(19) United States
(12) Patent Application Publication
(10) Pub. No.: US 2005/0216739 A1
(43) Pub. Date: Sep. 29, 2005

(54) Portable storage device and method of managing files in the portable storage device

(75) Inventors: Byung-rae Lee, Yongin-si (KR); Tae-sung Kim, Seoul (KR); Joong-chul Yoon, Seoul (KR); Kyung-im Jung, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/091,881

(22) Filed: Mar. 29, 2005

Related U.S. Application Data
(60) Provisional application No. 60/575,757, filed on Jun. 1, 2004.

(30) Foreign Application Priority Data
Mar. 29, 2004 (KR) 10/2004-0021295

(51) Int. Cl. H04L 9/00

(52) U.S. Cl. 713/168

(57) ABSTRACT

A portable storage device and method of managing a file in the portable storage device are provided. The portable storage device includes a control module sorting digital rights management data from received data and forming a file comprising the digital rights management data, and a storage module storing the file. The method includes sorting digital rights management data from received data, forming a file comprising the digital rights management data, and storing the file in a storage module. Accordingly, files can be securely managed to be suitable to DRM.

### CROSS-REFERENCE TO RELATED APPLICATIONS

This application claims priority from Korean Patent Application No. 10-2004-0021295 filed on Mar. 29, 2004 in the Korean Intellectual Property Office, and U.S. Provisional Patent Application No. 60/575,757 filed on Jun. 1, 2004 in the United States Patent and Trademark Office, the disclosures of which are incorporated herein by reference in their entirety.

### BACKGROUND OF THE INVENTION

1. Field of the Invention

The present invention relates to a method of managing files in a portable storage device, and more particularly, to a method of managing files in a portable storage device enabling digital rights management (DRM).

2. Description of the Related Art

Recently, digital rights management (DRM) has been actively researched and developed. Commercial services using DRM have already been used or will be used. Unlike analog data, digital content can be copied without loss and can be easily reused, processed, and distributed, and only a small amount of cost is needed to copy and distribute the digital content. However, a large amount of cost, labor, and time are needed to produce the digital content. Thus, DRM has gradually increased in its application areas.

There has been much effort expended to protect digital content. Conventionally, digital content protection has concentrated on preventing non-authorized access to digital content, so that only people who have paid charges are permitted to access the digital content. Thus, people who have paid to access the digital content are allowed access to unencrypted digital content, while people who have not paid charges are not allowed such access. In this case, when a person who has paid charges intentionally distributes the digital content to other people, however, these other people can use the digital content without paying charges.

In DRM, however, any one is allowed to freely access encoded digital content, but a license referred to as a rights object is needed to decode and execute the digital content. Accordingly, the digital content can be more effectively protected by using DRM.

FIG. 1 is a conceptual diagram of conventional DRM. DRM relates to management of contents (hereafter, referred to as encrypted contents) protected using a method such as encryption or scrambling and rights objects allowing access to the encrypted contents.

Referring to FIG. 1, a DRM system includes devices 110 and 150 wanting to access encrypted content, a contents issuer 120 issuing content, a rights issuer 130 issuing a rights object (RO) containing a license to execute the content, and a certification authority 140 issuing a certificate.

The device 110 can obtain desired content from the contents issuer 120 in an encrypted format protected by DRM. The device 110 can obtain a license to play the encrypted content from a rights object received from the rights issuer 130.

Since encrypted contents can be circulated or distributed freely, the device 110 can freely transmit the encrypted content to the device 150. The device 150 needs the rights object to play the encrypted content. The rights object can be obtained from the rights issuer 130.

An RO containing a license to execute content may also contain predetermined constraint information so that the RO can be prevented from being distributed or copied without permission. For example, the RO may contain information regarding a limited number of times the RO can be copied or moved from one device to another device. In this case, whenever the RO is moved or copied, a copy or move count set in the RO increases by one. When the copy or move count reaches the predetermined limited number of times, the RO is prohibited from being moved or copied so that the RO is prevented from being distributed without permission.

Meanwhile, the certification authority 140 issues a certificate containing information on an identifier of a device whose public key is validated, a serial number of the certificate, a certificate authority's name, a public key of the pertinent device, and an expiry of the certificate issued. The certificate provides information on whether the devices are proper users or not. Thus, it is possible to prevent an invader device pretending that it is an authenticate device from communicating with other devices or systems.

In this way, DRM protects the profits of those producing or providing digital contents and thus may be helpful in promoting growth in the digital content industry.

In addition to the direct transfer of encrypted content between devices as shown in FIG. 1, recently, a technique of transferring an RO and encrypted content between devices via a portable storage device has been developed.

Accordingly, to apply DRM technology to a portable storage device intermediating between devices, a technique of securely managing files in the portable storage device is desired.

### SUMMARY OF THE INVENTION

The present invention provides a method of securely managing files in a portable storage device having a digital rights management (DRM) function.

The above stated object as well as other objects, features and advantages, of the present invention will become clear to those skilled in the art upon review of the following description, the attached drawings and appended claims.

According to an aspect of the present invention, there is provided a portable storage device including a control module sorting DRM data from received data and forming a file comprising the DRM data, and a storage module storing the file.

Preferably, but not necessarily, the control module sets a restricted region in the storage module, allocates a file identifier mapped to the restricted region to the file comprising the digital rights management data, and stores the file identifier in the restricted region.

Here, the file stored in the storage module may have a tree structure.

The digital rights management data may be one of a rights object and authentication information needed for authentication with a device.

The authentication information may be one of a certificate and a certificate revocation list.

The file comprising the digital rights management data may comprise a rights object dedicated file comprising an elementary file for a rights object and an authentication dedicated file comprising an elementary file for the authentication information.

The control module may comprise an access condition for restricting the device's access to the file stored in the storage module.

The access condition for the file comprising the digital rights management data may be authentication. When the device accesses the file comprising the authentication information to update one of the certificate and the certificate revocation list, the access condition is authentication and valid duration of the certificate or the certificate revocation list.

Preferably, but not necessarily, the control module generates a table in which an identifier of content that can be executed by the rights object or an identifier of the rights object is mapped to a file identifier allocated to the rights object elementary file, searches the table for the rights object that the device attempts to access, and allows the device to access the rights object.

In addition, when the device accesses a file in the portable storage device, the device sends a command to the control module, and in response to the command the control module accesses the file and performs an operation according to the command.

According to another aspect of the present invention, there is provided a method of managing a file in a portable storage device, including sorting digital rights management data from received data, forming a file comprising the digital rights management data, and storing the file in a storage module.

Preferably, but not necessarily, the storing of the file comprises setting a restricted region in the storage module using a control module, and allocating a file identifier mapped to the restricted region to the file comprising the digital rights management data.

The file stored in the storage module may have a tree structure.

The digital rights management data may be one of a rights object and authentication information needed for authentication with a device.

The authentication information may be one of a certificate and a certificate revocation list.

The file comprising the digital rights management data may comprise a rights object dedicated file comprising an elementary file for a rights object and an authentication dedicated file comprising an elementary file for the authentication information.

The method may further comprise causing a control module to generate an access condition for restricting the device's access to the file stored in the storage module.

The access condition for the file comprising the digital rights management data may be authentication.

When the device accesses the file comprising the authentication information to update one of the certificate and the certificate revocation list, the access condition may be authentication and valid duration of the certificate or the certificate revocation list.

The control module generates a table in which an identifier of content that can be executed by the rights object or an identifier of the rights object is mapped to a file identifier allocated to the rights object elementary file, searches the table for the rights object that the device attempts to access, and allows the device to access the rights object.

The device accesses a file in the portable storage device, the device sends a command to the control module, and in response to the command the control module accesses the file and performs an operation according to the command.

### BRIEF DESCRIPTION OF THE DRAWINGS

The above and other features and advantages of the present invention will become more apparent by describing in detail preferred embodiments thereof with reference to the attached drawings in which:

FIG. 1 is a conceptual diagram of conventional digital rights management (DRM);

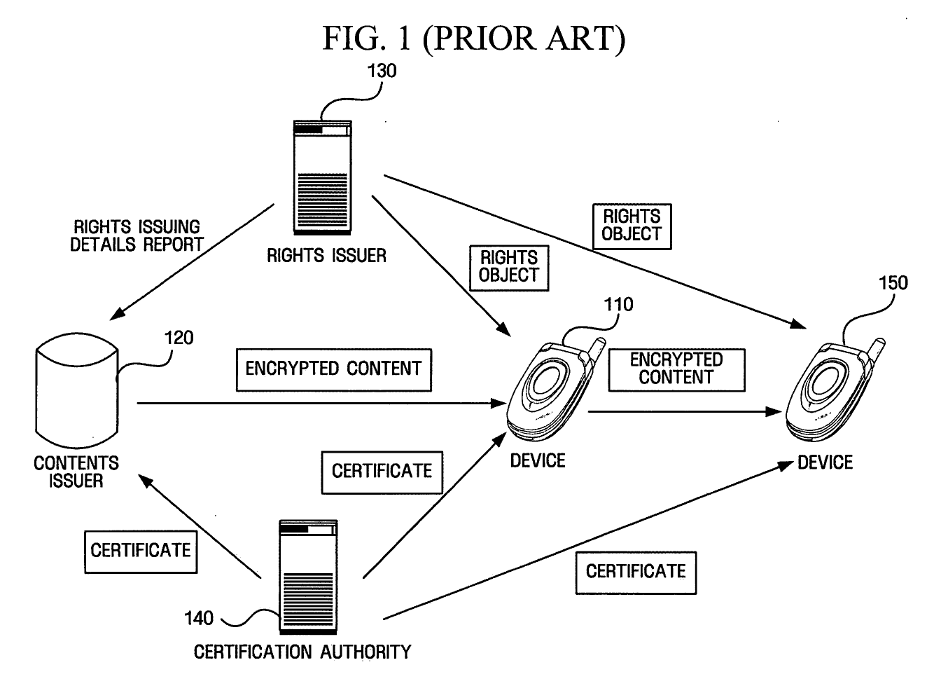

FIG. 2 is a schematic conceptual diagram of DRM between a portable storage device and a device;

FIG. 3 is a diagram illustrating authentication between a device and a multimedia card according to an embodiment of the present invention;

FIG. 4 is a block diagram of a portable storage device according to an embodiment of the present invention;

FIG. 5 is a schematic diagram illustrating a directory structure stored in a storage module according to an embodiment of the present invention;

FIG. 6 is a table illustrating the configuration of a rights object (RO) according to an embodiment of the present invention;

FIG. 7 is a table illustrating constraints given to permission shown in FIG. 6;

FIG. 8 illustrates the configuration of an RO file supported by a multimedia card according to an embodiment of the present invention;

FIG. 9 is a table showing information regarding a tag according to a type of data included in a file;

FIG. 10 is a flowchart of a procedure for storing data in a multimedia card according to an embodiment of the present invention; and

FIG. 11 is a flowchart of a procedure for permitting access to a file stored in a multimedia card according to an embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown. A portable storage device used in the present invention includes a non-volatile memory such as a flash memory which data can be written to, read from, and deleted from and which can be connected to a device. Examples of such portable storage device are smart media, memory sticks, compact flash (CF) cards, xD cards, and multimedia cards. Hereinafter, a MMC will be explained as a portable storage device. However, the portable storage device according to the present invention is not restricted to a multimedia card.

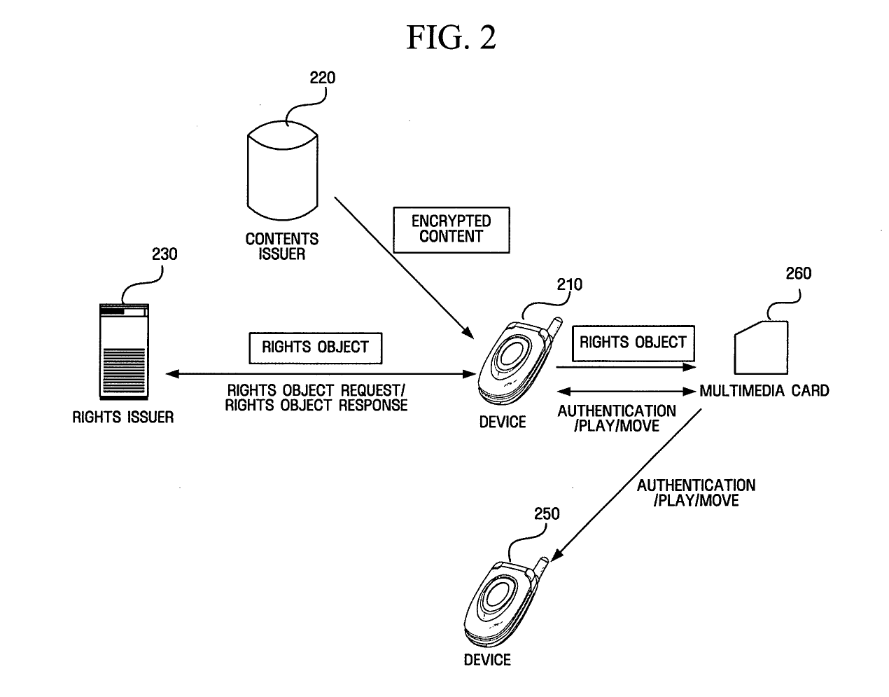

FIG. 2 is a conceptual diagram of digital rights management (DRM) between a multimedia card and a device.

A device 210 can obtain encrypted content from a contents issuer 220. The encrypted content is content protected through DRM. To play the encrypted content, a rights object (RO) for the encrypted content is needed. The RO may contain a definition of a right to content and constraints to the right and may further include a right to the RO itself.

An example of the right to the RO may be move or copy. In other words, an RO containing a right to move may be moved to another device or a MMC. An RO containing a right to copy may be copied to another device or a MMC.

The move of the RO is a process of generating the RO at a new place and deactivating it at the previous place (i.e., the RO itself is deleted or a right contained in the RO is deleted). On the other hand, when the RO is copied, the RO at an original place remains in an activated state.

After obtaining the encrypted content, the device 210 may purchase an RO from a rights issuer 230 to obtain a right to play. When the device 210 obtains the RO from the rights issuer 230, the device 210 can play the encrypted content using the RO. Meanwhile, the device 210 may transfer (move or copy) the RO to a device 250 through a multimedia card 260.

The device 210 can move the RO to the multimedia card 260 after authenticating with the multimedia card 260. To play the encrypted content using the RO moved to the multimedia card 260, the device 210 may request a right to play from the multimedia card 260 and receive the right to play, i.e., a content encryption key (CEK), from the multimedia card 260.

Meanwhile, the device 250 can receive a right to play particular content from the multimedia card 260 storing ROs after authenticating with the multimedia card 260 and can play the encrypted particular content using the received right. Here, as described above, a play count included in the RO stored in the multimedia card 260 may be increased.

An RO may be moved or copied from the multimedia card 260 to the device 250. Here, as described above, a move or copy count of the RO may be increased. After authenticating with the multimedia card 260, the device 210 or 250 is permitted to play an encrypted content using a right contained in an RO, or move or copy an RO until a play, move or copy count reaches a predetermined limited number set in the RO.

As described above, it is preferable that a device authenticates with a multimedia card before exchanging data such as an RO with the multimedia card.

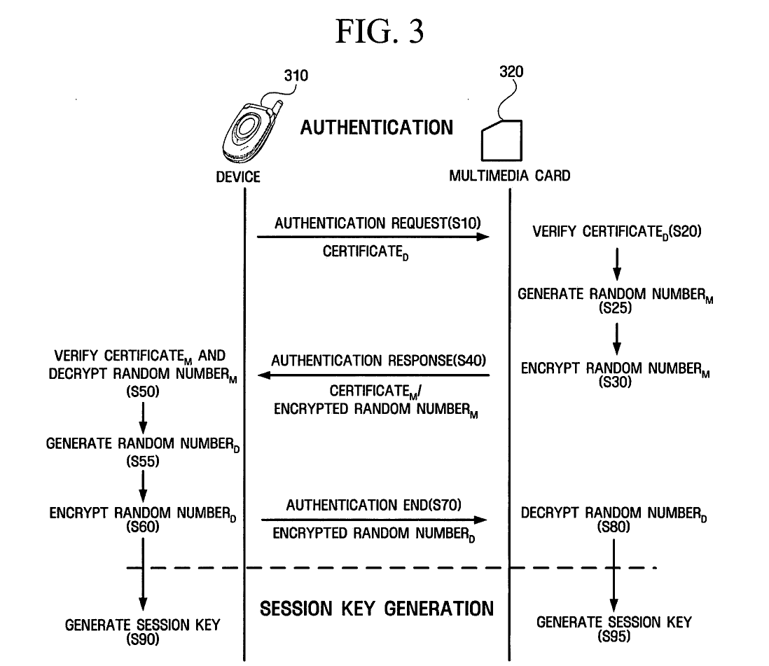

FIG. 3 is a diagram illustrating authentication between a device 310 and a multimedia card 320 according to an embodiment of the present invention. Authentication is a procedure in which the device 310 and the multimedia card 320 authenticate each other's genuineness and exchange random numbers for generation of a session key. A session key can be generated using a random number obtained during authentication. In FIG. 3, descriptions above horizontal arrowed lines relate to a command requesting another device to perform a certain operation and descriptions below the horizontal arrow-headed lines relate to a parameter needed to execute the command or data transported.

In the embodiment illustrated in FIG. 3 and other embodiments hereinafter, the device 310 issues all commands for the authentication and the multimedia card 320 performs operations needed to execute the command. For example, the device 310 may send a command such as an authentication request to the multimedia card 320. Then, the multimedia card 320 sends a certificate_{M} and an encrypted random number_{M} to the device 310 in response to the authentication request. Accordingly, each horizontal arrow in FIG. 3 denotes a moving direction of a parameter or data.

In another embodiment of the present invention, both of the device 310 and the multimedia card 320 may issue commands. For example, the multimedia card 320 may send the authentication response together with the certificate_{M} and the encrypted random number_{M} to the device 310.

In FIG. 3, a subscript “D” of an object indicates that the object is stored in or generated by the device 310 and a subscript “M” of an object indicates that the object is stored in or generated by the multimedia card 320.

The authentication will be described in detail with reference to FIG. 3 below. In operation S10, the device 310 sends an authentication request to the multimedia card 320 together with a device certificates. The device certificate_{D} includes an identifier (ID) of the device 310, i.e., a device ID, and a device public key_{D} and is signed with a digital signature of a certification authority.

In operation S20, the multimedia card 320 verifies whether the device certificate_{D} is valid using a certificate revocation list (CRL) stored therein. If the device certificate_{D} is registered in the CRL, the multimedia card 320 may reject the authentication with the device 310. If the device certificate_{D} is not registered in the CRL, the multimedia card 320 verifies that the device certificate_{D} is valid and obtains the device public key_{D} from the device certificate_{D}.

The multimedia card 320 verifying that the device certificates_{D} is valid generates a random number_{M} in operation S25 and encrypts the random number_{M} using the device public key_{D} in operation S30. Thereafter, in operation S40, an authentication response procedure is performed by sending an authentication response from the device 310 to the multimedia card 320 or from the multimedia card 320 to the device 310. During the authentication response procedure, the multimedia card 320 sends a multimedia card public certificate_{M} and an encrypted random number_{M} to the device 310.

In operation S50, the device 310 receives the multimedia card certificate_{M} and the encrypted random number_{M} and authenticates the multimedia card 320 by verifying the multimedia card certificate_{M} based on the CRL. In addition, the device 310 obtains the multimedia card public key_{M} from the multimedia card certificate_{M} and obtains the random number_{M} generated by the multimedia card 320 by decrypting the encrypted random number_{M} using its private key.

In operation S55, the device 310 generates a random number_{D}. In operation S60, the device 310 encrypts the random number_{D} using the multimedia card public key_{M}. Thereafter, an authentication end procedure is performed in operation S70 where the device 310 sends the encrypted random number_{D} to the multimedia card 320.

In operation S80, the multimedia card 320 receives and decrypts the encrypted random number_{D} using its private key. As a result, the device 310 and the multimedia card 320 know the random numbers (the random number_{D} and the random number_{M}) generated by each other.

In operations S90 and S95, the device 310 and the multimedia card 320 that share each other's random numbers generates their session keys using both of their two random numbers. The session keys are identical with each other. Once the session keys are generated, diverse operations protected by DRM can be performed between the device 310 and the multimedia card 320.

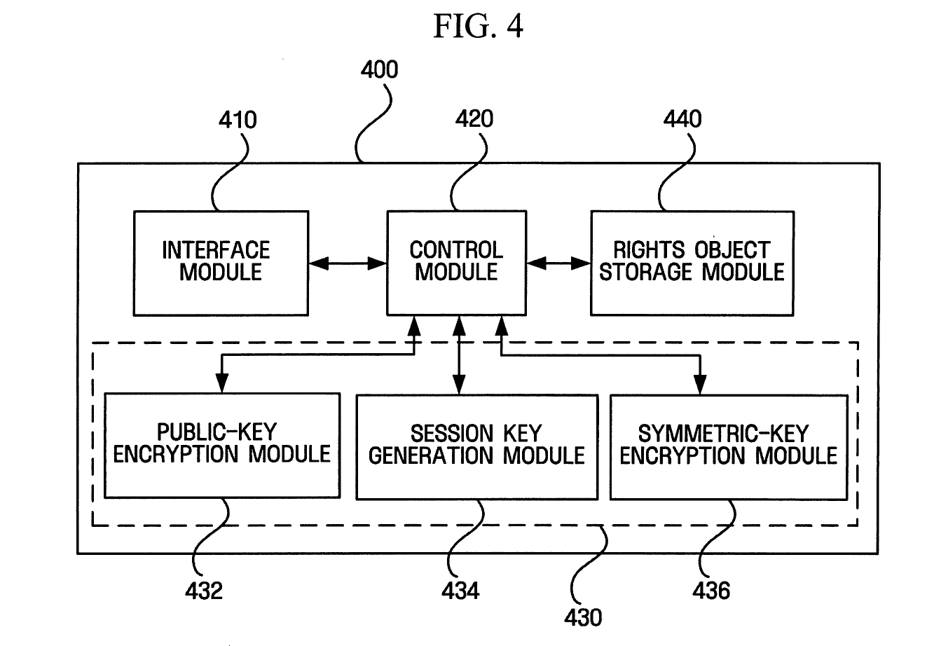

FIG. 4 is a block diagram of a portable storage device, e.g., a multimedia card 400, according to an embodiment of the present invention.

In the illustrative embodiment, the term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or MMC.

To implement DRM, the multimedia card 400 needs a security function, a function of storing content or an RO, a function of exchanging data with a device, and a DRM function. To perform these functions, the multimedia card 400 includes an encryption module 430 with a security function, a storage module 440 with a storage function, an interface module 410 allowing data exchange with a device, and a control module 420 controlling each module to perform a DRM procedure.

The interface module 410 allows the MMC 400 to be connected with the device. When the MMC 100 is connected with the device, the interface module 410 of the MMC 100 may be electrically connected with an interface module of the device. However, the electrical connection is just an example, and the connection may indicate a state in which the MMC 100 can communicate with the device through a wireless medium without a contact.

The encryption module 430 includes a public-key encryption module 432, a session key generation module 434, and a symmetric-key encryption module 436.

The public-key encryption module 432 performs public-key encryption. More particularly, the public-key encryption module 432 performs RSA encryption according to a request from the control module 420. During the above-described authentication, the RSA encryption may be used for random number exchange or digital signature. The public-key encryption module 432 is just an example, and other public-key encryption schemes, including Diffie-Hellman encryption, RSA encryption, ElGamal encryption, and elliptic curve encryption, can be used.

The session key generation module 434 generates a random number to be transmitted to a device and generates a session key using the generated random number and a random number received from the device. The random number generated by the session key generation module 434 is encrypted by the public-key encryption module 432 and then transmitted to the device through the interface module 410. Instead of generating the random number in the session key generation module 434, the random number may be selected from a plurality of random numbers provided in advance.

The symmetric-key encryption module 436 performs symmetric-key encryption. More particularly, the symmetric-key encryption module 436 performs advanced encryption standard (AES) encryption using the session key generated by the session key generation module 434. The AES encryption is usually used to encrypt a CEK included in an RO using the session key when the CEK is transmitted to a device. In addition, encryption by the symmetric-key encryption module 436 may be used to encrypt other important information during communication with a device. In an embodiment of the present invention, the AES encryption using the session key may be performed to encrypt an RO during move of the RO. The AES encryption is just an example, and the symmetric-key encryption module 436 may use other symmetric-key encryption such as data encryption standard (DES) encryption.

The control module 420 may divide the storage module 440 into a restricted region and a normal region, encrypt and store DRM-related information in the restricted region, and store other data in the normal region. The DRM-related information may include authentication information needed to verify the authenticity of the identity of a device during authentication with the device and an RO including a right to use content and right information. The authentication information may be a certification of the multimedia card 400, a certification of a certification authority, or a CRL.

The control module 420 may restrict a device's access to the DRM-related information among data stored in the storage module by dividing the storage module 440 into the restricted region and the normal region and storing the DRM-related information in the restricted region. The storage module 440 may be physically or logically divided into the restricted region and the normal region.

To restrict a device's access to the DRM-related information, the control module 420 may set a condition for access to data stored in the storage module 440. The access condition may be authentication, necessity of the update of the certification of the multimedia card 400, or necessity of the update of a CRL stored in the storage module 440.

For example, the control module 420 may set authentication as access restriction information regarding an RO. When a device attempts to access an RO, the control module 420 may determine whether the device has performed authentication with the multimedia card 400 and allow the device to access the RO only when the device has completed the authentication normally. Here, access may indicate read or write.

When an RO is copied or moved from a device to the multimedia card 400, the control module 420 may determine whether the device has authenticated with the multimedia card 400 and permits the copy or move only when the authentication has been done.

In another example, an access condition for a certificate or a CRL will be described. When a device accesses the multimedia card 400 to read a certificate or a CRL, the control module 420 may set no access conditions to allow the device to access without authentication. When the device's access is for the update of a certificate or a CRL, the control module 420 may set authentication and the valid duration of the certificate or the CRL as access conditions.

Meanwhile, the control module 420 may encrypt DRM data to be stored in the storage module 440 using a unique encryption key of the multimedia card 400 and store in the restricted region of the storage module 440 the encrypted DRM data together with a file identifier (FID) allocated to address the DRM data to the restricted region. Encryption of the DRM-related information may be performed partially or entirely. For example, when an RO is encrypted and stored, only a CEK included in the RO may be encrypted or the entire RO may be encrypted. When ROs are entirely encrypted, the control module 420 may map an ID of each RO or an ID of content that can be played by each RO to an FID and separately store a table of content IDs or RO IDs to facilitate searching for a particular RO.

The storage module 440 stores encrypted content, an RO, a CRL, etc. The storage module 440 may be divided into the restricted region and the normal region physically or logically.

Data stored in the storage module 440 may have a file format in a tree structure. DRM data such as an RO or a CRL may be stored in the restricted region in an encrypted state. Here, the symmetric-key encryption module 426 may encrypt an RO using a unique encryption key that other devices cannot read according to the AES encryption. In addition, the symmetric-key encryption module 436 may decrypt the encrypted RO using the unique encryption key when the RO is moved or copied to other devices. Use of symmetric-key encryption is just an example. In another example, the public-key encryption module 432 may perform public-key encryption using a public key of the multimedia card 400 and perform decryption using a private key of the multimedia card 400 when necessary. Encrypted contents or data for other applications may be stored in the normal region of the storage module 440.

As described above, access to the restricted region of the storage module 440 may be selectively restricted by the control module 420.

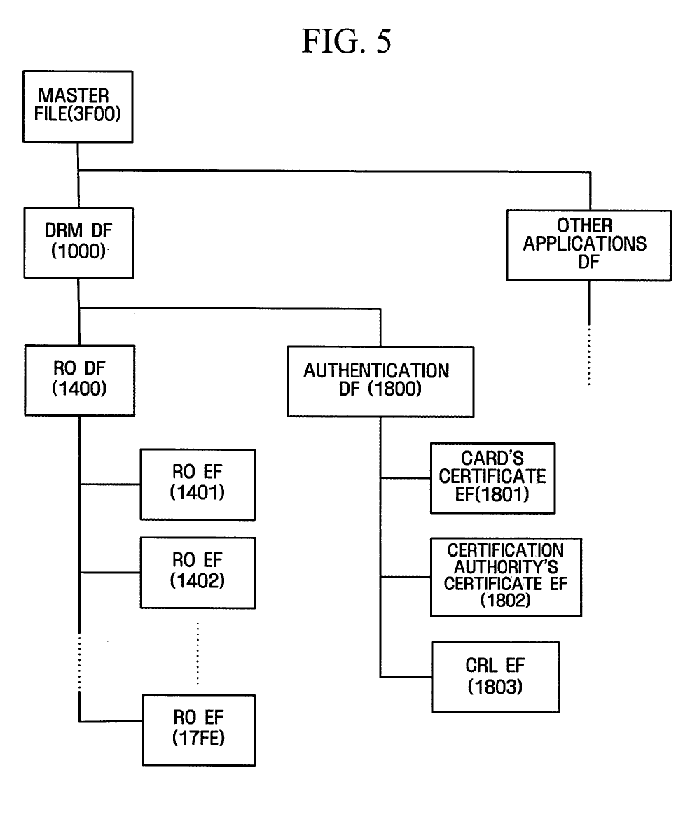

FIG. 5 is a schematic diagram illustrating a directory structure stored in the storage module 440 according to an embodiment of the present invention.

The restricted region of the storage module 440 included in the multimedia card 400 may be protected by setting access conditions. A tree structure may be used as a file structure for appropriately utilizing the access conditions.

The file structure of the multimedia card 400 illustrated in FIG. 5 includes a master file (MF) corresponding to an entire directory, a dedicated file (DF) corresponding to a sub-directory, and a plurality of elementary files (EFs) storing necessary content. To identify these files, FIDs may be used. In FIG. 5, a number in each parenthesis denotes an FID. In the embodiment illustrated in FIG. 5, since an FID ranges from 1401 to 17FE, 1023 RO EFs can be generated.

DFs may be divided into a DRM DF for the DRM of the multimedia card 400 and other DF applications. The DRM DF may be stored in the restricted region of the storage module 440. The control module 420 may set an access condition such that only a device completing authentication with the multimedia card 400 can access the DRM DF. When the access condition is not satisfied, the control module 420 may prohibit the access to the DRM DF. In describing the present invention, “access” may indicate indirect access in which a device sends a command to the multimedia card 400 and then the control module 420 of the multimedia card 400 accesses a relevant file and inputs/outputs necessary information.

For the DRM of the multimedia card 400, the DRM DF may include an RO DF and an authentication DF. The RO DF includes RO EFs storing an RO, which may have been stored in the multimedia card 400 since manufacturing or may be copied or moved from a device after authentication.

The authentication DF includes information needed by the multimedia card 400 to perform authentication with a device. The authentication DF includes a card's certificate EF containing the certificate of the multimedia card 400, a certification authority's certificate EF containing a certificate of a certification authority, or a CRL EF containing a CRL.

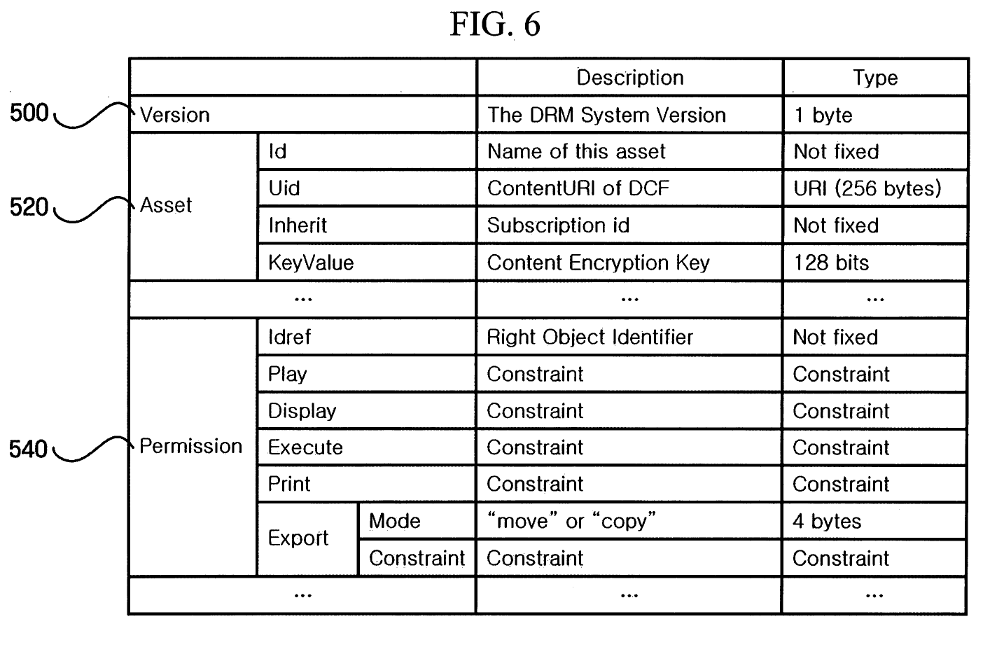

FIG. 6 illustrates the configuration of an RO according to an embodiment of the present invention.

The RO includes a version field 500, an asset field 520, and a permission field 540.

The version field 500 contains version information of a DRM system. The asset field 520 contains information regarding content data, the consumption of which is managed by the RO. The permission field 540 contains information regarding usage and action that are permitted by a right issuer with respect to the content protected through DRM.

In information stored in the asset field 520, “id” information indicates an identifier used to identify the RO and “uid” information is used to identify the content the usage of which is dominated by the RO and is a uniform resource identifier (URI) of content data of a DRM content format (DCF). “KeyValue” information contains a binary key value used to encrypt the content, which is referred to as a CEK. The CEK is a key value used to decrypt encrypted content to be used by a device. When the device receives the CEK from a multimedia card, it can use the content.

The information stored in the permission field 540 will be described in detail. “Permission” is a right to use content permitted by the right issuer. Types of permission include “Play”, “Display”, “Execute”, “Print”, and “Export”.

The Play component indicates a right to express DRM content in an audio/video format. A DRM agent does not allow an access based on Play with respect to content such as JAVA games that cannot be expressed in the audio/video format.

The Play component may optionally have a constraint. If a specified constraint is present, the DRM agent grants a right to Play according to the specified constraint. If no specified constraints are present, the DRM agent grants unlimited Play rights.

The Display component indicates a right to display DRM content through a visual device. A DRM agent does not allow an access based on Display with respect to content such as gif or jpeg images that cannot be displayed through the visual device.

The Execute component indicates a right to execute DRM content such as JAVA games and other application programs.

The Print component indicates a right to generate a hard copy of DRM content such as jpeg images.

The Export component indicates a right to send DRM contents and corresponding ROs to a DRM system other than an open mobile alliance (OMA) DRM system or a content protection architecture. The Export component must have a constraint. The constraint specifies a DRM system of a content protection architecture to which DRM content and its RO can be sent. The Export component is divided into a move mode and a copy mode. When an RO is exported from a current DRM system to another DRM system, the RO is deleted from the current DRM system in the move mode but is not deleted from the current DRM system in the copy mode.

When an RO is exported to another system, the Move component deactivates the original RO in the current DRM system, while the Copy component does not deactivate the original RO in the current DRM system.

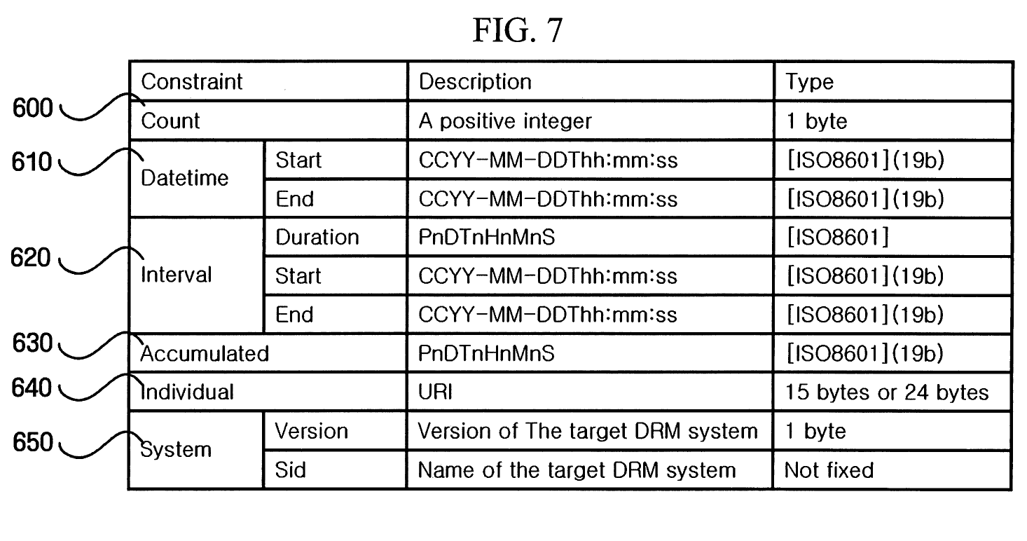

FIG. 7 is a table illustrating constraints given to permission shown in FIG. 6.

Consumption of digital content is restricted by constraints to “Permission”.

A Count constraint 600 has a positive integer value and specifies the count of permissions granted to content.

A Datetime constraint 610 specifies a duration for permission and selectively contains a start component or an end component. When the start component is contained, use of the DRM content is not permitted before a specified time/date. When the end component is contained, use of the DRM content is not permitted after a specified time/date.

An Interval constraint 620 specifies a time interval at which an RO can be executed for the corresponding DRM content. When a start component is contained in the Interval constraint 620, consumption of the DRM content is permitted during a period of time specified by a duration component contained in the Interval constraint 620 after a specified time/date. When an end component is contained in the Interval constraint 620, consumption of the DRM content is permitted during the period of time specified by the duration component before a specified time/date.

An Accumulated constraint 630 specifies a maximum time interval for an accumulated measured period of time while the RO is executed for the corresponding DRM content. If the accumulated measured period of time exceeds the maximum time interval specified by the Accumulated constraint 630, a DRM agent does not permit an access to the DRM content.

An Individual constraint 640 specifies a person to whom the DRM content is bound.

A System constraint 650 specifies a DRM system or a content protection architecture to which the content and the RO can be exported. A version component specifies version information of the DRM system or the content protection architecture. A “sid” component specifies a name of the DRM system or the content protection architecture.

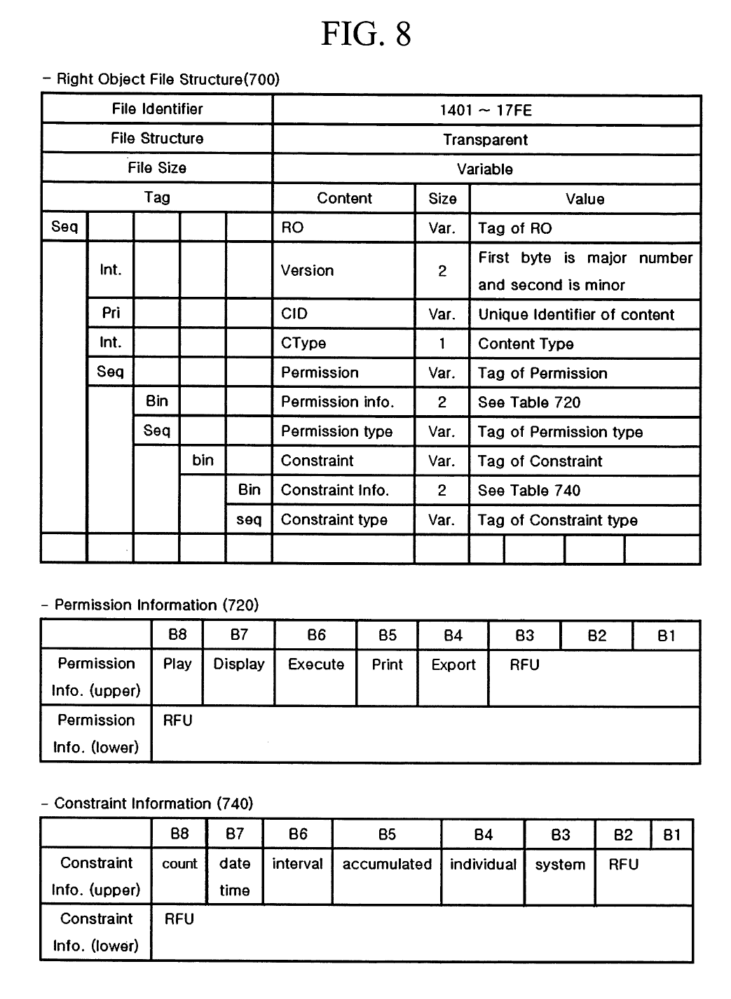

FIG. 8 illustrates the configuration of an RO file supported by a multimedia card according to an embodiment of the present invention.

In the illustrated table, “Seq” denotes a sequence, “Oct” denotes an octet string, “Int” denotes an integer, and “Bin” denotes a binary data type.

The multimedia card usually has smaller storage capacity than a device and thus supports a small data structure like an RO file structure 700. The RO file structure 700 includes a tag of an RO, a content ID, a content type, permission-related data, and constraint-related data. The permission-related data includes a tag indicating that current data relates to permission, a bit string (i.e., permission information) 720 indicating the content of the permission, and a tag indicating a type of the permission. The constraint-related data includes a tag indicating that current data relates to a constraint, a bit string (i.e., constraint information) 740 indicating the content of the constraint, and a tag indicating a type of the constraint.

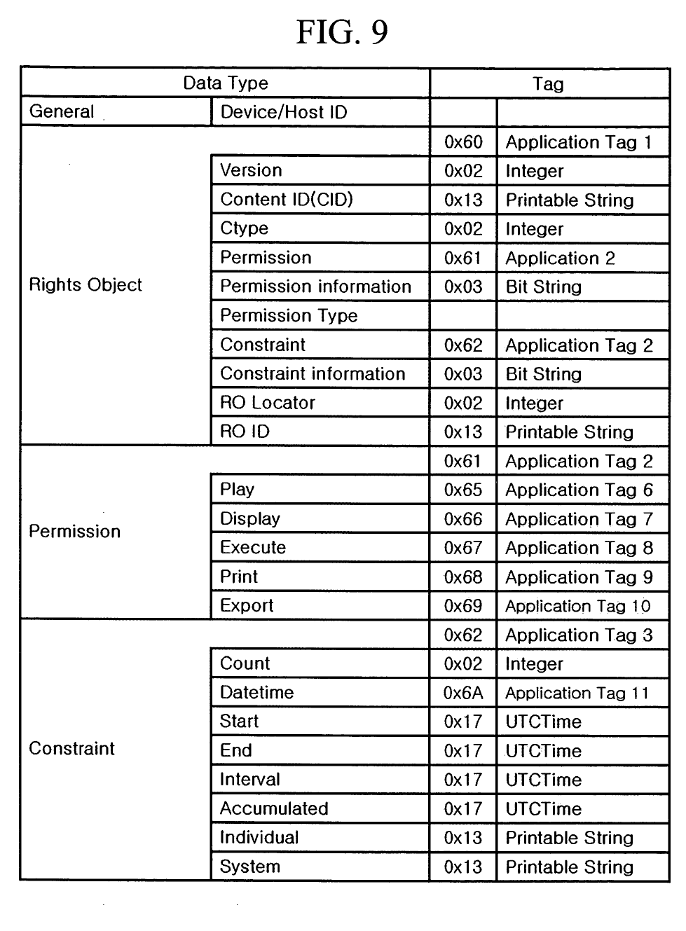

Information regarding a tag according to a type of data included in a file is illustrated in FIG. 9.

In the above-described embodiments, the function of the DRM agent may be performed by the control module 420 of the multimedia card 400.

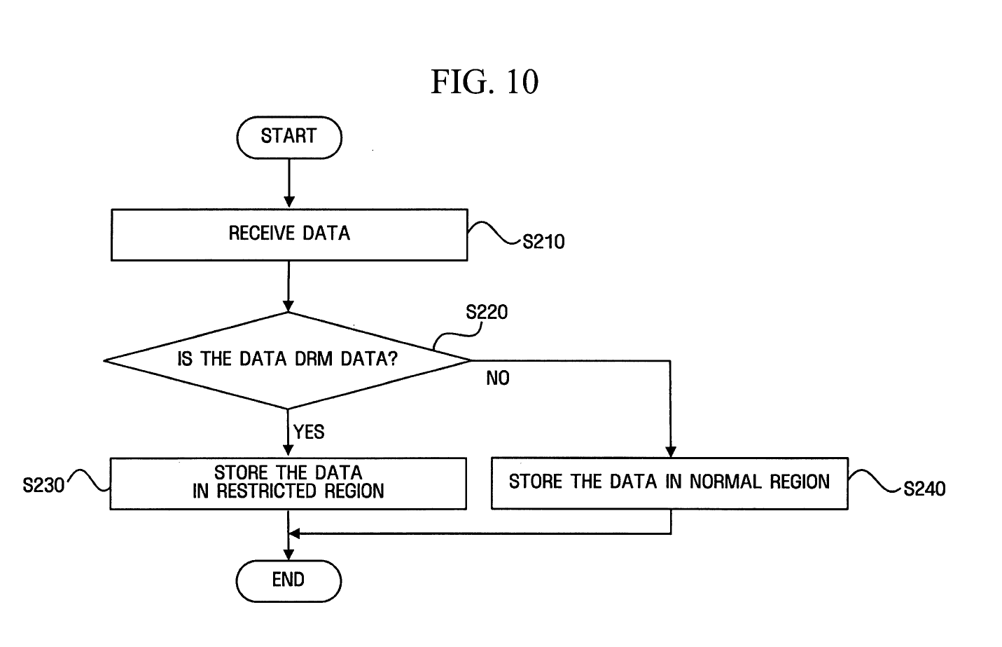

FIG. 10 is a flowchart of a procedure for storing data in a multimedia card according to an embodiment of the present invention.

In operation S210, data is received from a device which the multimedia card has authenticated. In operation S220, the multimedia card determines whether the data is DRM data, which is needed for DRM between the multimedia card and the device. The DRM data may be authentication information such as a certificate or a CRL needed for authentication or an RO including a license to use particular content.

When it is determined that the data is DRM data, in operation S230 the control module 420 (FIG. 4) may store the data in a restricted region of the storage module 440 (FIG. 4). For this operation, the control module 420 may divide the storage module 440 into a restricted region for storing DRM data and a normal region for storing other data. The storage module 440 may be divided physically or logically.

In addition, the control module 420 may set an access condition for data stored in the storage module 440 to restrict access by the device. The access condition may be authentication, necessity of the update of the multimedia card's certificate, or necessity of the update of a CRL stored in the storage module 440.

For example, the control module 420 may set authentication as access restriction information regarding an RO. When a device attempts to access an RO, the control module 420 may determine whether the device has performed authentication with the multimedia card and allow the device to access the RO only when the device has completed the authentication normally. Here, access may indicate read or write. When an RO is copied or moved from a device to the multimedia card, the control module 420 may determine whether the device has authenticated with the multimedia card and permits the copy or move only when the authentication has been done.

In another example, an access condition for a certificate or a CRL will be described. When a device accesses the multimedia card to read a certificate or a CRL, the control module 420 may set no access conditions to allow the device to access without authentication. When the device's access is for the update of a certificate or a CRL, the control module 420 may set authentication and the valid duration of the certificate or the CRL as access conditions.

Meanwhile, the control module 420 may encrypt DRM data to be stored in the storage module 440 using a unique encryption key of the multimedia card and store in the restricted region of the storage module 440 the encrypted DRM data together with an FID allocated to address the DRM data to the restricted region. Encryption of the DRM-related information may be performed partially or entirely. For example, when an RO is encrypted and stored, only a CEK included in the RO may be encrypted or the entire RO may be encrypted. When ROs are entirely encrypted, the control module 420 may map an ID of each RO or an ID of content that can be played by each RO to an FID and separately store a table of content IDs or RO IDs to facilitate searching for a particular RO.

Data stored in the storage module 440 may have a tree structure and may be divided into a DF for an RO and DF for authentication information.

When the data is other data such as encrypted content, in operation S240 the data is stored in the normal region.

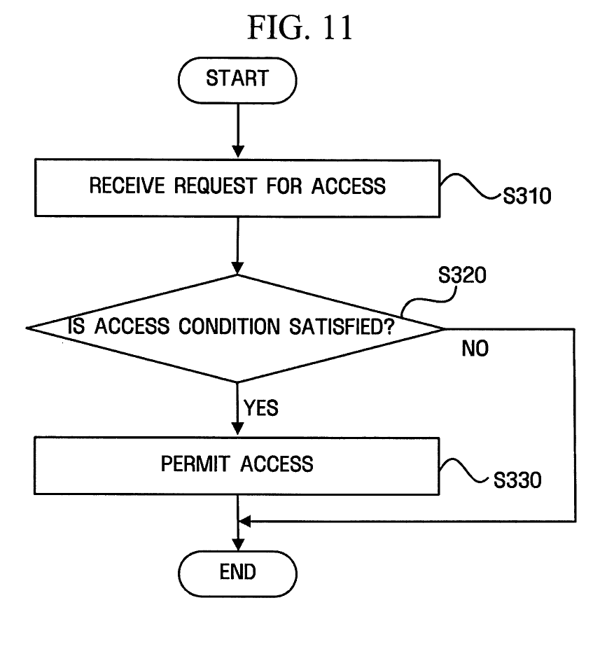

FIG. 11 is a flowchart of a procedure for permitting access to a file stored in a multimedia card according to an embodiment of the present invention.

In operation S310, a request for access to the storage module 440 (FIG. 4) of the multimedia card is received from a device. In operation S320, the control module 420 (FIG. 4) of the multimedia card determines whether an access condition for a particular file that the device attempts to access is satisfied. The access condition has been described above.

When it is determined that the access condition is satisfied, in operation S330, the control module 420 permits the device to access the particular file. The device's access may be indirect access in which the device sends a command to the multimedia card and then the control module 420 of the multimedia card accesses the file and inputs/outputs necessary information. Alternatively, when a table in which a content ID or an RO ID is mapped to an FID is used, the device sends an ID of an RO that the device attempts to access or an ID of content that can be executed by the RO that the device attempts to access to the multimedia card. Then, the table is searched for an FID to which the received ID is mapped, and the RO is found using the FID and is accessed.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

As described above, according to the present invention, files can be securely managed to be suitable to DRM.

1. A portable storage device comprising:
a control module sorting digital rights management data from received data and forming a file comprising the digital rights management data; and
a storage module storing the file.

2. The portable storage device of claim 1, wherein the control module sets a restricted region in the storage module, allocates a file identifier mapped to the restricted region to the file comprising the digital rights management data, and stores the file in the restricted region.

3. The portable storage device of claim 2, wherein the file stored in the storage module has a tree structure.

4. The portable storage device of claim 2, wherein the digital rights management data is one of a rights object and authentication information needed for authentication with a device.

5. The portable storage device of claim 4, wherein the authentication information is one of a certificate and a certificate revocation list.

6. The portable storage device of claim 5, wherein the file comprising the digital rights management data comprises a rights object dedicated file comprising an elementary file for a rights object and an authentication dedicated file comprising an elementary file for the authentication information.

7. The portable storage device of claim 6, wherein the control module comprises an access condition for restricting the device's access to the file stored in the storage module.

8. The portable storage device of claim 7, wherein the access condition for the file comprising the digital rights management data is authentication.

9. The portable storage device of claim 7, wherein when the device accesses the file comprising the authentication information to update one of the certificate and the certificate revocation list, the access condition is authentication and valid duration of the certificate or the certificate revocation list.

10. The portable storage device of claim 6, wherein the control module generates a table in which an identifier of content that can be executed by the rights object or an identifier of the rights object is mapped to a file identifier allocated to the rights object elementary file, searches the table for the rights object that the device attempts to access, and allows the device to access the rights object.

11. The portable storage device of claim 10, wherein when the device accesses a file in the portable storage device, the device sends a command to the control module, and in response to the command the control module accesses the file and performs an operation according to the command.

12. A method of managing a file in a portable storage device, comprising:
sorting digital rights management data from received data;
forming a file comprising the digital rights management data; and
storing the file in a storage module.

13. The method of claim 12, wherein the storing of the file comprises:
setting a restricted region in the storage module using a control module; and
allocating a file identifier mapped to the restricted region to the file comprising the digital rights management data and storing the file in the restricted region.

14. The method of claim 13, wherein the file stored in the storage module has a tree structure.

15. The method of claim 13, wherein the digital rights management data is one of a rights object and authentication information needed for authentication with a device.

16. The method of claim 15, wherein the authentication information is one of a certificate and a certificate revocation list.

17. The method of claim 16, wherein the file comprising the digital rights management data comprises a rights object dedicated file comprising an elementary file for a rights object and an authentication dedicated file comprising an elementary file for the authentication information.

18. The method of claim 17, further comprising causing a control module to generate an access condition for restricting the device's access to the file stored in the storage module.

19. The method of claim 18, wherein the access condition for the file comprising the digital rights management data is authentication.

20. The method of claim 17, wherein when the device accesses the file comprising the authentication information to update one of the certificate and the certificate revocation list, the access condition is authentication and valid duration of the certificate or the certificate revocation list.

21. The method of claim 17, wherein the control module generates a table in which an identifier of content that can be executed by the rights object or an identifier of the rights object is mapped to a file identifier allocated to the rights object elementary file, searches the table for the rights object that the device attempts to access, and allows the device to access the rights object.

22. The method of claim 21, wherein when the device accesses a file in the portable storage device, the device sends a command to the control module, and in response to the command the control module accesses the file and performs an operation according to the command.
